(19) United States
(12) Patent Application Publication
(10) Pub. No.: US 2024/0360959 A1
(43) Pub. Date: Oct. 31, 2024

(54) HYDROGEN SUPPLY DEVICE

(71) Applicant: TOYOTA JIDOSHA KABUSHIKI KAISHA, Toyota-shi (JP)

(72) Inventors: Ryota IWASAKI, Okazaki-shi (JP); Koji Wada, Nagoya-shi (JP); Tomoyuki Matsuo, Toyota-shi (JP); Tomohiro Nakano, Nagoya-shi (JP)

(73) Assignee: TOYOTA JIDOSHA KABUSHIKI KAISHA, Toyota-shi (JP)

(21) Appl. No.: 18/426,608

(22) Filed: Jan. 30, 2024

(30) Foreign Application Priority Data
Apr. 27, 2023 (JP) 2023-073256

(51) Int. Cl. F17C 7/04; H01M 8/04082

(52) U.S. Cl. CPC F17C 7/04; F17C 2221/012; F17C 2223/0161; F17C 2227/0309; F17C 2250/03; F17C 2250/043; F17C 2250/0439; F17C 2265/065; F17C 2270/0168; F17C 2270/0184; H01M 8/04208; H01M 2250/20

(57) ABSTRACT

A hydrogen supply device including a heater, a vaporizer, a circulation flow path for circulating a heat medium between the heater and the vaporizer, a pressure of a heat medium of the vaporizer, a temperature of a heat medium of the vaporizer, and a control unit to which a temperature of hydrogen gas flowing out of the vaporizer is input, wherein the control unit limits an output of the hydrogen engine based on the pressure, the temperature, and the temperature of the hydrogen gas.

### CROSS-REFERENCE TO RELATED APPLICATION

This application claims priority to Japanese Patent Application No. 2023-073256 filed on Apr. 27, 2023, incorporated herein by reference in its entirety.

### BACKGROUND

### 1. Technical Field

The present disclosure relates to control of a hydrogen supply device that vaporizes liquid hydrogen and supplies a hydrogen gas.

### 2. Description of Related Art

Japanese Unexamined Patent Application Publication No. 2019-210976 (JP 2019-210976 A) discloses a technique of detecting a differential pressure between an inlet and an outlet of a flow path for a liquefied natural gas (LNG) in a heat exchanger that exchanges heat between liquid hydrogen and LNG, and detecting freezing of the flow path for LNG when the differential pressure is large. JP 2019-210976 A also indicates that, when the above differential pressure is large, the liquid hydrogen is caused to flow through a bypass flow path that bypasses the heat exchanger to reduce the flow rate of the liquid hydrogen flowing through the heat exchanger.

### SUMMARY

In recent years, hydrogen engine vehicles provided with a hydrogen engine that directly burns a hydrogen gas instead of gasoline have been used. In these hydrogen engine vehicles, a hydrogen gas obtained by vaporizing liquid hydrogen using a vaporizer is supplied to a hydrogen engine. The vaporizer is a heat exchanger between liquid hydrogen and a heating medium, and a gas such as a helium gas which is difficult to freeze is used as the heating medium. When a gas is used as the heating medium, however, the vaporizer may become large in size. Therefore, it has been studied to use a liquid such as water as the heating medium. When a liquid heating medium is used, however, the heat exchange performance of the vaporizer may deteriorate due to the freezing of the heating medium, and a hydrogen gas at an extremely low temperature may flow into a hydrogen pipe to damage the hydrogen pipe. Therefore, when a liquid heating medium is used for the vaporizer, it is necessary to suppress freezing of the heating medium.

Therefore, an object of the hydrogen supply device according to the present disclosure is to suppress freezing of a heating medium in a vaporizer that uses a liquid as the heating medium.

An aspect of the present disclosure provides a hydrogen supply device including:
a heater that heats a liquid heating medium;
a vaporizer that vaporizes liquid hydrogen into a hydrogen gas using the heated heating medium;
a circulation flow path that circulates the heating medium between the heater and the vaporizer; and
a control unit that receives as an input one or a plurality of a pressure of the heating medium of the vaporizer, a temperature of the heating medium of the vaporizer, and a temperature of the hydrogen gas flowing out of the vaporizer, in which
the control unit is configured to limit an output of a power unit, to which the hydrogen gas is supplied, based on one or a plurality of the pressure of the heating medium of the vaporizer, the temperature of the heating medium of the vaporizer, and the temperature of the hydrogen gas flowing out of the vaporizer.

Consequently, it is possible to suppress freezing of a heating medium in a vaporizer that uses a liquid as the heating medium.

In the hydrogen supply device according to the aspect of the present disclosure,
the control unit may be further configured to:
receive as inputs an inlet pressure of the heating medium of the vaporizer and an outlet pressure of the heating medium of the vaporizer; and
limit the output of the power unit, to which the hydrogen gas is supplied, when a differential pressure between the inlet pressure and the outlet pressure is equal to or more than a predetermined pressure threshold.

Since the output of the power unit is limited by detecting freezing based on the differential pressure in this manner, the freezing of the heating medium can be effectively suppressed.

In the hydrogen supply device according to the aspect of the present disclosure,
the control unit may be further configured to:
receive as an input a temperature of the heating medium flowing out of the vaporizer; and
limit the output of the power unit, to which the hydrogen gas is supplied, when the temperature of the heating medium is less than a predetermined temperature threshold.

Since the output of the power unit is limited by detecting freezing based on the temperature of the heating medium flowing out of the vaporizer in this manner, the freezing of the heating medium can be effectively suppressed.

In the hydrogen supply device according to the aspect of the present disclosure,
the control unit may be further configured to:
receive as an input the temperature of the hydrogen gas flowing out of the vaporizer; and
limit the output of the power unit, to which the hydrogen gas is supplied, when the temperature of the hydrogen gas is less than a predetermined hydrogen gas temperature threshold.

Since the output of the power unit is limited based on the temperature of the hydrogen gas flowing out of the vaporizer in this manner, the supply of a hydrogen gas at an extremely low temperature can be effectively suppressed.

In the hydrogen supply device according to the aspect of the present disclosure,
the control unit may be further configured to:
receive as inputs an inlet pressure of the heating medium of the vaporizer, an outlet pressure of the heating medium of the vaporizer, a temperature of the heating medium flowing out of the vaporizer, and the temperature of the hydrogen gas flowing out of the vaporizer; and
limit the output of the power unit, to which the hydrogen gas is supplied, when a differential pressure between the inlet pressure and the outlet pressure is equal to or more than a predetermined pressure threshold, when the temperature of the heating medium is less than a predetermined temperature threshold, or when the temperature of the hydrogen gas is less than a predetermined hydrogen gas temperature threshold.

Since the output of the power unit is limited based on one of a plurality of detected values or the plurality of detected values in this manner, the freezing of the heating medium can be effectively suppressed.

The hydrogen supply device according to the aspect of the present disclosure can suppress freezing of a heating medium in a vaporizer that uses a liquid as the heating medium.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a system diagram illustrating a hydrogen supply device of an embodiment and a configuration of a hydrogen engine vehicle on which the hydrogen supply device is mounted;

FIG. 2 is a flowchart showing the operation of the hydrogen supply device shown in FIG. 1;

FIG. 3 is a flow chart showing another operation of the hydrogen supply device shown in FIG. 1; and

FIG. 4 is a flow chart showing another operation of the hydrogen supply device shown in FIG. 1.

### DETAILED DESCRIPTION OF EMBODIMENTS

Hereinafter, a hydrogen supply device 100 according to an embodiment will be described with reference to the drawings. In the following description, it is assumed that the hydrogen supply device 100 supplies hydrogen gas to the hydrogen engine 15, which is a power unit mounted on the hydrogen engine vehicle 200.

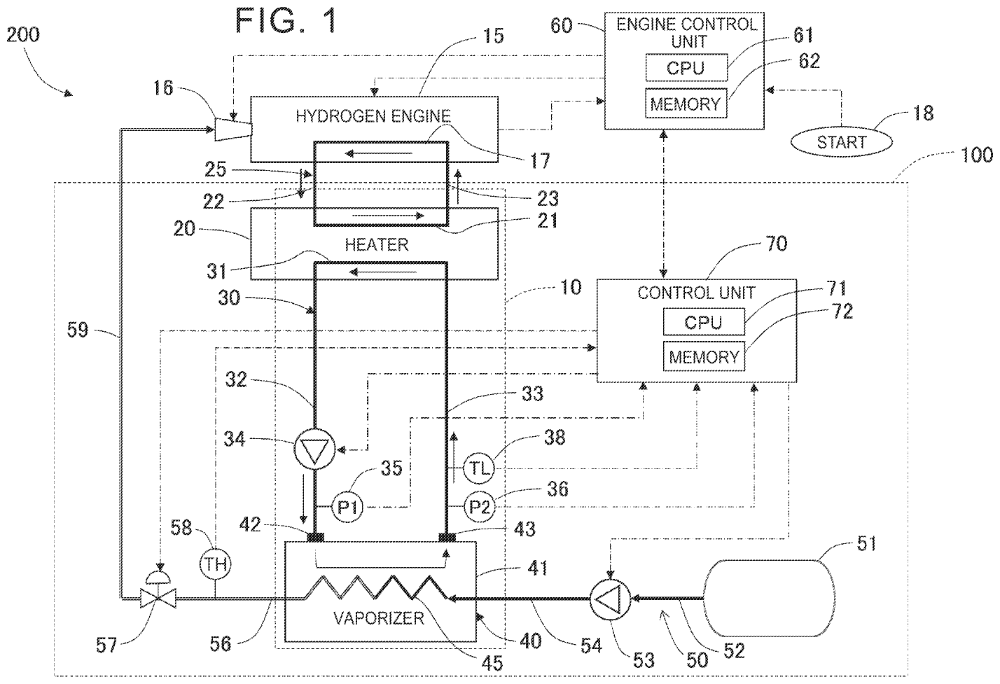

As illustrated in FIG. 1, the hydrogen supply device 100 includes a heating circuit 10 that heats the heat medium and supplies the heat medium to the vaporizer 40, a hydrogen circuit 50 that supplies the hydrogen gas vaporized by the vaporizer 40 to the hydrogen engine 15, and a control unit 70. First, the heating circuit 10 will be described. The heating circuit 10 includes a heater 20, a vaporizer 40, a circulation flow path 30, and a circulation pump 34.

The heater 20 includes a coolant flow path 21 and a heat medium flow path 31 therein. In the coolant flow path 21, the coolant having a high temperature flowing through the internal flow path 17 of the hydrogen engine 15 flows. The low-temperature heat medium flowing through the casing 41 of the vaporizer 40 flows through the heat medium flow path 31. The heater 20 performs heat exchange between the coolant having a high temperature flowing through the coolant flow path 21 and the low-temperature heat medium to heat the heat medium. Here, the heating medium is a liquid, and may be, for example, a long-life coolant (LLC).

The coolant flow path 21 is connected to the internal flow path 17 by a coolant supply pipe 22 and a coolant return pipe 23. The internal flow path 17, the coolant flow path 21, the coolant supply pipe 22, and the coolant return pipe 23 form a coolant circulation flow path 25 for circulating the coolant between the hydrogen engine 15 and the heater 20. The coolant circulation flow path 25 circulates the coolant whose temperature is increased in the hydrogen engine 15 to the coolant flow path 21 of the heater 20.

The vaporizer 40 includes a casing 41 and a hydrogen tube 45 housed inside the casing 41. A heat medium having a high temperature heated by the heater 20 flows inside the casing 41. Low-temperature liquid hydrogen or hydrogen gas flows inside the hydrogen tube 45. The heat medium flowing through the inside of the casing 41 flows through the outer surface of the hydrogen tube 45, and the liquid hydrogen inside is heated and vaporized to form hydrogen gas.

The circulation flow path 30 includes a heat medium flow path 31 of the heater 20, a heat medium supply pipe 32, a casing 41 of the vaporizer 40, and a heat medium return pipe 33. The heat medium supply pipe 32 connects the outlet of the heat medium flow path 31 and the heat medium inlet 42 of the vaporizer 40. The heat medium return pipe 33 connects the heat medium outlet 43 of the vaporizer 40 and the inlet of the heat medium flow path 31. Further, the heat medium supply pipe 32 is provided with a circulation pump 34 for feeding the heat medium to the circulation flow path 30. An inlet pressure sensor 35 for detecting the vaporizer inlet heat medium pressure P1 is provided in the vicinity of the heat medium inlet 42 of the heat medium supply pipe 32. An outlet pressure sensor 36 for detecting the vaporizer outlet heat medium pressure P2 and a heat medium temperature sensor 38 for detecting the vaporizer outlet heat medium temperature TL are provided in the vicinity of the heat medium outlet 43 of the heat medium return pipe 33.

The heat medium pressurized by the circulation pump 34 flows into the casing 41 from the heat medium inlet 42 through the heat medium supply pipe 32. The heat medium flows through the outer surface of the hydrogen tube 45 inside the casing 41, exchanges heat with the low-temperature liquid hydrogen flowing in the hydrogen tube 45, and the temperature decreases. The heat medium having a reduced temperature flows out from the heat medium outlet 43 of the vaporizer 40 to the heat medium return pipe 33. The heat medium flows from the heat medium return pipe 33 into the heat medium flow path 31 of the heater 20. Then, the heat medium having an increased temperature by heat exchange with the coolant having a high temperature flowing through the coolant flow path 21 in the heat medium flow path 31 flows back from the heat medium supply pipe 32 to the circulation pump 34.

Next, the hydrogen circuit 50 will be described. The hydrogen circuit 50 includes a liquid hydrogen tank 51, a liquid hydrogen pump inlet pipe 52, a liquid hydrogen pump 53, a liquid hydrogen inlet pipe 54, a hydrogen tube 45, a hydrogen gas outlet pipe 56, a pressure reducing valve 57, and a hydrogen gas supply pipe 59.

The liquid hydrogen tank 51 is a tank for storing low-temperature liquid hydrogen therein. The liquid hydrogen pump inlet pipe 52 connects the liquid hydrogen tank 51 and the suction port of the liquid hydrogen pump 53. The liquid hydrogen inlet pipe 54 connects the discharge port of the liquid hydrogen pump 53 and the inlet of the hydrogen tube 45. The hydrogen gas outlet pipe 56 connects the outlet of the hydrogen tube 45 and the pressure reducing valve 57. A hydrogen gas temperature sensor 58 for detecting the vaporizer outlet hydrogen gas temperature TH is attached to the hydrogen gas outlet pipe 56. The hydrogen gas supply pipe 59 connects the pressure reducing valve 57 to the injector 16 of the hydrogen engine 15.

The cryogenic liquid hydrogen stored in the liquid hydrogen tank 51 is pressurized by the liquid hydrogen pump 53 and flows into the hydrogen tube 45 from the liquid hydrogen pump inlet pipe 52. The liquid hydrogen flowing in the hydrogen tube 45 exchanges heat with a heat medium having a high temperature flowing through the outer surface of the hydrogen tube 45, and is vaporized to form hydrogen gas. The hydrogen gas flowing in the hydrogen tube 45 exchanges heat with a heat medium having a high temperature flowing through the outer surface of the hydrogen tube 45, becomes hydrogen gas at a predetermined temperature, and flows out from the outlet of the hydrogen tube 45 to the hydrogen gas outlet pipe 56. After the pressure of the hydrogen gas is reduced to the supply pressure to the hydrogen engine 15 by the pressure reducing valve 57, the hydrogen gas is supplied to the injector 16 of the hydrogen engine 15 through the hydrogen gas supply pipe 59. The hydrogen gas is combusted inside the hydrogen engine 15 to generate a driving force, and the temperature of the coolant flowing through the internal flow path 17 is increased.

The hydrogen engine 15 is controlled by an engine control unit 60. The engine control unit 60 is a computer including a CPU 61 that is a processor that performs information processing therein, and a memory 62 that stores control programs and control data. The engine control unit 60 adjusts the opening degree of the injector 16 to adjust the output of the hydrogen engine 15. A start switch 18 attached to the hydrogen engine vehicle 200 is connected to the engine control unit 60. The engine control unit 60 starts the hydrogen engine 15 when the start switch 18 is turned ON, and stops the hydrogen engine 15 when the start switch 18 is turned OFF. In addition, the engine control unit 60 communicates with the control unit 70 described later to exchange information. The engine control unit 60 outputs an on/off signal of the start switch 18 to the control unit 70. Further, the engine control unit 60 receives a hydrogen engine output limit signal and a hydrogen engine stop signal from the control unit 70.

The control unit 70 is a computer including a CPU 71 that is a processor that performs information processing therein, and a memory 72 that stores control programs and control data. The circulation pump 34 and the liquid hydrogen pump 53 are connected to the control unit 70 and operate according to a command from the control unit 70. The inlet pressure sensor 35, the outlet pressure sensor 36, the heat medium temperature sensor 38, and the hydrogen gas temperature sensor 58 are connected to the control unit 70. The vaporizer inlet heat medium pressure P1 detected by the inlet pressure sensor 35, the vaporizer outlet heat medium pressure P2 detected by the outlet pressure sensor 36, the vaporizer outlet heat medium temperature TL detected by the heat medium temperature sensor 38, and the vaporizer outlet hydrogen gas temperature TH detected by the hydrogen gas temperature sensor 58 are inputted to the control unit 70. Further, the control unit 70 exchanges information with the engine control unit 60. The control unit 70 receives an on/off signal of the start switch 18 from the engine control unit 60. Further, the control unit 70 outputs the generated hydrogen engine output limit signal and hydrogen engine stop signal to the engine control unit 60.

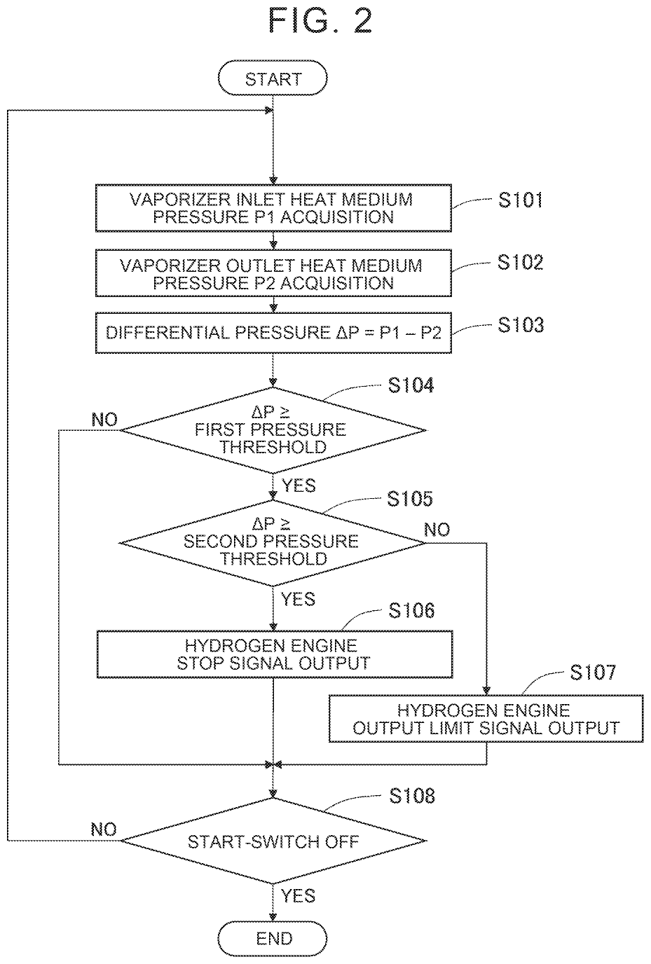

Next, the operation of the hydrogen supply device 100 will be described with reference to FIG. 2. The control unit 70 repeatedly executes S108 operation from S101 of FIG. 2 until the start switch 18 is turned off at a predetermined control timing.

When the start switch 18 is turned on, the hydrogen engine 15 and the hydrogen supply device 100 are started. The control unit 70 of the hydrogen supply device 100 acquires the vaporizer inlet heat medium pressure P1 by the inlet pressure sensor 35 in S101 of FIG. 2. Then, the control unit 70 acquires the vaporizer outlet heat medium pressure P2 by the outlet pressure sensor 36 in S102 of FIG. 2. Then, in S103 of FIG. 2, the control unit 70 calculates the differential pressure ΔP by Equation 1 below.

Differential pressure ΔP=P1−P2 (Equation 1)

The control unit 70 determines whether the differential pressure ΔP is equal to or greater than the first pressure threshold in S104 of FIG. 2. Here, the first pressure threshold value may be set to, for example, about twice the maximum differential pressure when the duty of the circulation pump 34 in the normal state without freezing is 100%. Then, when the control unit 70 determines NO in S104 of FIG. 2, that is, when the differential pressure ΔP is less than the first pressure threshold, it determines that freezing of the heat medium has not occurred, and proceeds to S108 of FIG. 2. The control unit 70 determines whether the off-signal of the start switch 18 is received from the engine control unit 60 in S108. When determining NO in S108 of FIG. 2, the control unit 70 returns to S101 of FIG. 2 and repeatedly executes S104, S108 operation from S101. On the other hand, if S108 in FIG. 2 indicates YES, the control unit 70 terminates the process.

If S104 in FIG. 2 determines that the heating medium is YES, the control unit 70 determines that freezing of the heating medium has started, and proceeds to S105 in FIG. 2.

The control unit 70 determines whether the differential pressure ΔP is equal to or greater than the second pressure threshold in S105 of FIG. 2. Here, the second pressure threshold value may be, for example, the maximum allowable pressure of each flow path constituting the circulation flow path 30, or may be set to about three times the maximum differential pressure when the duty of the circulation pump 34 in a normal state without freezing is 100%. Then, when the control unit 70 determines NO in S105 of FIG. 2, that is, when the differential pressure ΔP is equal to or greater than the first pressure threshold and less than the second pressure threshold, it determines that freezing has started but there is a flow of the thermal medium. If S105 of FIG. 2 determines that the output is NO, the control unit 70 proceeds to S107 of FIG. 2, generates a hydrogen-engine output limit signal, and outputs the hydrogen-engine output limit signal to the engine control unit 60. Upon receiving the hydrogen engine output limit signal from the control unit 70, the engine control unit 60 reduces the output of the hydrogen engine 15 to a predetermined output. As a result, the flow rate of the liquid hydrogen or the hydrogen gas flowing through the hydrogen tube 45 of the vaporizer 40 is reduced.

On the other hand, when S105 in FIG. 2 determines YES, that is, when the differential pressure ΔP is equal to or higher than the second pressure threshold, the control unit 70 determines that the blockage has occurred in some part of the circulation flow path 30 due to the freezing. Then, the control unit 70 proceeds to S106 of FIG. 2, generates a hydrogen-engine stopping signal, and outputs the hydrogen-engine stopping signal to the engine control unit 60. Upon receiving the hydrogen engine stop signal from the control unit 70, the engine control unit 60 stops the hydrogen engine 15. As a result, the flow rate of the liquid hydrogen or the hydrogen gas flowing in the hydrogen tube 45 of the vaporizer 40 becomes zero.

After executing the operation of S106 or S107 in FIG. 2, the control unit 70 proceeds to S108 in FIG. 2. Then, in the same manner as described above, the control unit 70, when it is determined that S108 of FIG. 2 is NO, S101 of FIG. 2 returns to repeatedly execute the operation of S108 from S101, if it is determined YES in S108 of FIG. 2, the process ends.

As described above, the control unit 70 repeatedly executes S108 operation from S101 of FIG. 2 until the start switch 18 is turned off at a predetermined control timing. When the differential pressure ΔP is less than the first pressure threshold and the control unit 70 determines that S104 in FIG. 2 is NO, the control unit 70 does not execute S107 from S105 in FIG. 2 and does not output the hydrogen engine output limiting signal and the hydrogen engine stopping signal to the engine control unit 60. In this case, the hydrogen engine 15 is operated without an output limit.

When the control unit 70 determines that the differential pressure ΔP is YES in S104 of FIG. 2 between the first pressure threshold and the second pressure threshold and determines that the differential pressure ΔP is NO in S105 of FIG. 2, the control unit 70 repeatedly executes S105 and S107 from S101 of FIG. 2. As a result, the output limit state of the hydrogen engine 15 is maintained. When the output limiting state of the hydrogen engine 15 is maintained, the flow rate of the liquid hydrogen or the hydrogen gas is maintained to be low, so that the freezing is eliminated and the differential pressure ΔP decreases. When the differential pressure ΔP decreases to less than the first pressure threshold and the control unit 70 determines that S104 in FIG. 2 is NO, the control unit 70 does not execute S105, S107 in FIG. 2 and does not output the hydrogen-engine output limit signal to the engine control unit 60. When the input of the hydrogen engine output limit signal from the control unit 70 disappears, the engine control unit 60 releases the output limit of the hydrogen engine 15 and returns the hydrogen engine 15 to the normal output.

Similarly, when the differential pressure ΔP is equal to or higher than the second pressure threshold and the control unit 70 determines YES in S104 of FIG. 2 and determines YES in S105 of FIG. 2, the control unit 70 repeatedly executes S106 from S101 of FIG. 2. Thus, the stop state of the hydrogen engine 15 is maintained. When the stop state of the hydrogen engine 15 is maintained, a state in which the flow rate of the liquid hydrogen or the hydrogen gas is zero is maintained, so that the freezing is eliminated and the differential pressure ΔP decreases. When the differential pressure ΔP is less than the second pressure threshold and the control unit 70 determines NO in S105 of FIG. 2, the control unit 70 does not execute S106 of FIG. 2 and executes S107 of FIG. 2 to output the hydrogen-engine output-limit signal. When the hydrogen engine output limit signal is input from the control unit 70, the engine control unit 60 starts the hydrogen engine 15 to perform the output limit operation. Then, as described above, when freezing is eliminated, the differential pressure ΔP decreases to less than the first pressure threshold, and the control unit 70 determines NO in S104 of FIG. 2, the control unit 70 does not output the hydrogen engine output limit signal to the engine control unit 60, and the engine control unit 60 releases the output limit of the hydrogen engine 15 and returns the hydrogen engine 15 to the normal output.

As described above, when the differential pressure ΔP between the vaporizer inlet heat medium pressure P1 and the vaporizer outlet heat medium pressure P2 is equal to or higher than the predetermined pressure threshold, the control unit 70 limits the output of the hydrogen engine 15 or stops the hydrogen engine 15, and thus freezing of the liquid heat medium can be effectively suppressed. Further, it is possible to suppress the outflow of the cryogenic hydrogen gas from the vaporizer 40, and to suppress the damage of the seal members of the hydrogen gas outlet pipe 56, the pressure reducing valve 57, and the hydrogen gas supply pipe 59.

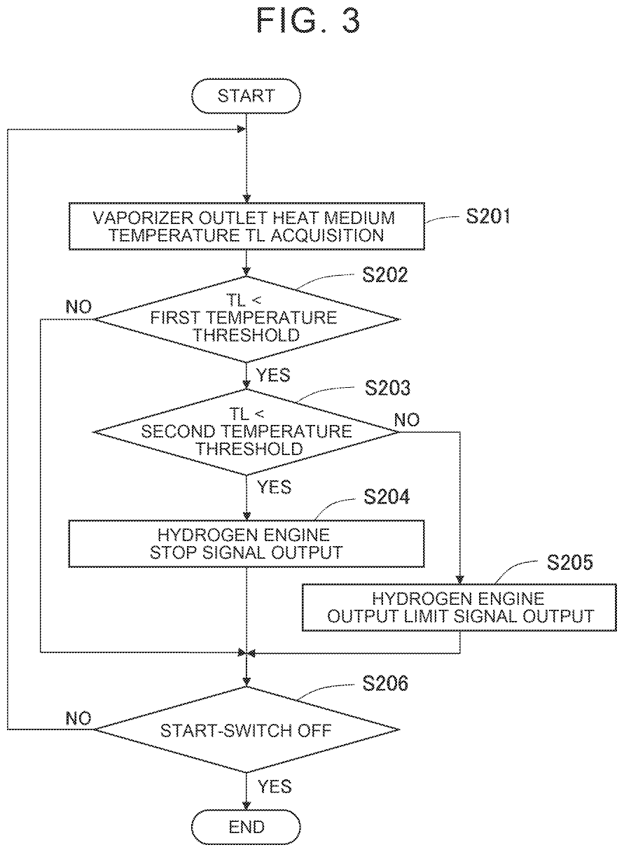

Next, another operation of the hydrogen supply device 100 will be described with reference to FIG. 3. Operations similar to those described above with reference to FIG. 2 will be briefly described. In another operation shown in FIG. 3, instead of the operation shown in FIG. 2 determining the output limit and the stop of the hydrogen engine 15 based on the differential pressure ΔP, the output limit and the stop of the hydrogen engine 15 are determined based on the vaporizer outlet heat medium temperature TL.

The control unit 70 acquires the vaporizer outlet heat medium temperature TL from the heat medium temperature sensor 38 in S201 of FIG. 3. Then, the control unit 70 determines whether or not the vaporizer outlet heat medium temperature TL is less than the first temperature threshold in S202 of FIG. 3. The first temperature threshold is a temperature indicating that the freezing of the heat medium has started on the outer surface of the hydrogen tube 45, and may be set to, for example, about ¼ of the freezing temperature (−TA (° C.)) of the heat medium (−TA/4 (° C.)), or may be determined by a test or the like.

If the control unit 70 determines NO in S202 of FIG. 3, the process proceeds to S206 of FIG. 3 without outputting the hydrogen engine output limiting signal and the hydrogen engine stopping signal, and repeatedly executes S201, S202, S206 of FIG. 3 until it is determined YES in S206 of FIG. 3.

When the control unit 70 determines YES in S202 of FIG. 3, that is, when the vaporizer outlet heat medium temperature TL becomes less than the first temperature threshold, it proceeds to S203 of FIG. 3 to determine whether or not the vaporizer outlet heat medium temperature TL is less than the second temperature threshold. Here, the second temperature threshold is a temperature at which the heat medium is frozen on the outer surface of the hydrogen tube 45 and the temperature of the hydrogen gas flowing out of the vaporizer 40 is estimated to decrease to the use lower limit temperature of the seal member used in the hydrogen gas outlet pipe 56, the pressure reducing valve 57, and the hydrogen gas supply pipe 59. For example, it may be set to about ½ (−TB/2 (° C.)) of the lower limit of use temperature (−TB (° C.)) of the sealing member, or may be determined by a test or the like.

When determining NO in S203 of FIG. 3, the control unit 70 proceeds to S205 of FIG. 3 to generate a hydrogen-engine output limit signal and output the hydrogen-engine output limit signal to the engine control unit 60. If S203 of FIG. 3 indicates YES, the process proceeds to S204 of FIG. 3 to generate a hydrogen-engine stopping signal and output the hydrogen-engine stopping signal to the engine control unit 60.

After executing S204 or S205 of FIG. 3, the control unit 70 proceeds to S206. In S206 of FIG. 3, the control unit 70 returns to NO, returns to S201, and when it is determined that YES is obtained by S206, the operation ends.

The control unit 70 repeatedly executes S206 operation from S201 of FIG. 3 until the start switch 18 is turned off at a predetermined control timing. Thus, the control unit 70 maintains a state in which the power of the hydrogen engine 15 is limited when the vaporizer outlet heat medium temperature TL is less than the first temperature threshold and is greater than or equal to the second temperature threshold, and maintains a stopped state of the hydrogen engine 15 when the vaporizer outlet heat medium temperature TL is less than the second temperature threshold. Thus, the hydrogen supply device 100 can effectively suppress the freezing of the liquid heat medium. Further, it is possible to suppress the outflow of the cryogenic hydrogen gas from the vaporizer 40, and to suppress the damage of the seal members of the hydrogen gas outlet pipe 56, the pressure reducing valve 57, and the hydrogen gas supply pipe 59.

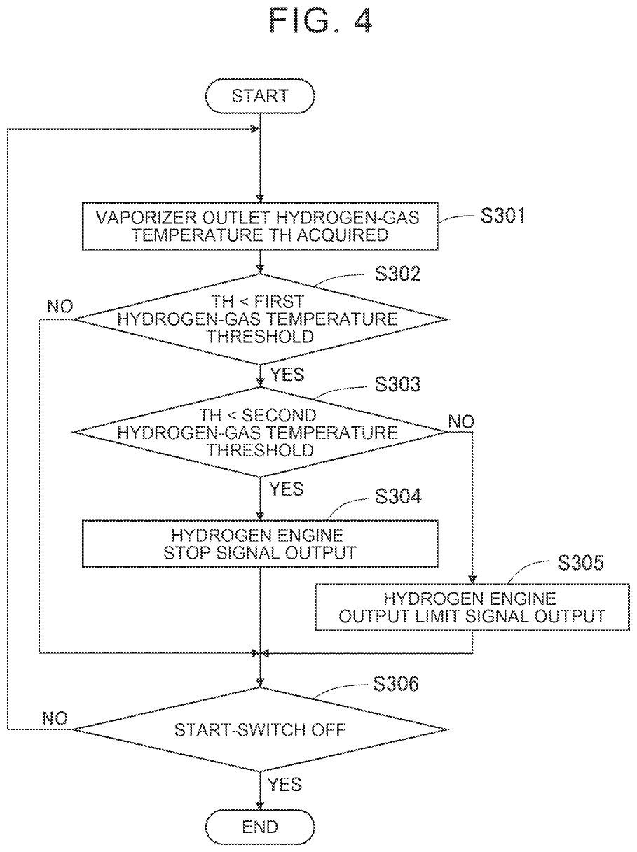

Next, another operation of the hydrogen supply device 100 will be described with reference to FIG. 4. The operation shown in FIG. 4 is such that, instead of the vaporizer outlet heat medium temperature TL of the operation described with respect to FIG. 2, the hydrogen engine 15 is stopped or power-limited based on the vaporizer outlet hydrogen gas temperature TH. The control unit 70 acquires the vaporizer outlet hydrogen gas temperature TH by the hydrogen gas temperature sensor 58 in S301 of FIG. 4, the vaporizer outlet hydrogen gas temperature TH in S302, S303 of FIG. 4, the first hydrogen gas temperature threshold, the hydrogen engine 15 is stopped based on the comparison of the second hydrogen gas temperature threshold, except that the output limiting is performed, it is the same as the operation described above with respect to FIG. 3.

Here, the first hydrogen gas temperature threshold is the temperature of the hydrogen gas estimated to be the freezing of the heat medium on the outer surface of the hydrogen tube 45, similar to the first temperature threshold, and may be set to, for example, about ¼ of the freezing temperature (−TA (C)) of the heat medium (−TA/4 (° C.)), or may be determined by a test or the like. The second hydrogen gas temperature threshold value is a temperature at which the temperature of the hydrogen gas is estimated to decrease to the lower limit temperature of use of the seal member used in the hydrogen gas outlet pipe 56 or the like, similar to the second temperature threshold value. For example, it may be set to about ½ (−TB/2 (° C.)) of the lower limit of use temperature (−TB (° C.)) of the sealing member, or may be determined by a test or the like.

In the operation shown in FIG. 4, as in the operation shown in FIG. 3, the freezing of the liquid heat medium can be effectively suppressed, and the seal member used in the hydrogen gas outlet pipe 56 or the like due to the outflow of the cryogenic gas from the vaporizer 40 can be suppressed from being damaged.

In the above description, the control unit 70 has been described as performing the operations described with reference to FIGS. 2, 3, and 4, but the present disclosure is not limited thereto. The control unit 70 may perform the three operations described with reference to FIGS. 2, 3, and 4 at the same time, and may output the hydrogen engine output restriction signal or the hydrogen engine stop signal to the engine control unit 60 to restrict or stop the output of the hydrogen engine 15 when the hydrogen engine output restriction signal or the hydrogen engine stop signal is generated in any one of the operations. As described above, since the output of the hydrogen engine 15 is limited and stopped by one or more detection values among the plurality of detection values, freezing of the heat medium can be effectively suppressed.

In the above description, the hydrogen supply device 100 supplies hydrogen gas to the hydrogen engine 15 of the hydrogen engine vehicle 200, but the present disclosure is not limited thereto. For example, hydrogen gas may be supplied to a fuel cell mounted on a vehicle. In this case, the freezing of the heat medium may be suppressed by limiting the output of the motor to which electric power is supplied from the fuel cell or stopping the motor. In this case, the fuel cell and the motor constitute a power unit of the vehicle.

What is claimed is:

1. A hydrogen supply device comprising:
a heater that heats a liquid heating medium;
a vaporizer that vaporizes liquid hydrogen into a hydrogen gas using the heated heating medium;
a circulation flow path that circulates the heating medium between the heater and the vaporizer; and
a control unit that receives as an input one or a plurality of a pressure of the heating medium of the vaporizer, a temperature of the heating medium of the vaporizer, and a temperature of the hydrogen gas flowing out of the vaporizer, wherein the control unit is configured to limit an output of a power unit, to which the hydrogen gas is supplied, based on one or a plurality of the pressure of the heating medium of the vaporizer, the temperature of the heating medium of the vaporizer, and the temperature of the hydrogen gas flowing out of the vaporizer.

2. The hydrogen supply device according to claim 1, wherein the control unit is further configured to:
receive as inputs an inlet pressure of the heating medium of the vaporizer and an outlet pressure of the heating medium of the vaporizer; and
limit the output of the power unit, to which the hydrogen gas is supplied, when a differential pressure between the inlet pressure and the outlet pressure is equal to or more than a predetermined pressure threshold.

3. The hydrogen supply device according to claim 1, wherein the control unit is further configured to:
receive as an input a temperature of the heating medium flowing out of the vaporizer; and
limit the output of the power unit, to which the hydrogen gas is supplied, when the temperature of the heating medium is less than a predetermined temperature threshold.

4. The hydrogen supply device according to claim 1, wherein the control unit is further configured to:
receive as an input the temperature of the hydrogen gas flowing out of the vaporizer; and
limit the output of the power unit, to which the hydrogen gas is supplied, when the temperature of the hydrogen gas is less than a predetermined hydrogen gas temperature threshold.

5. The hydrogen supply device according to claim 1, wherein the control unit is further configured to:
receive as inputs an inlet pressure of the heating medium of the vaporizer, an outlet pressure of the heating medium of the vaporizer, a temperature of the heating medium flowing out of the vaporizer, and the temperature of the hydrogen gas flowing out of the vaporizer; and
limit the output of the power unit, to which the hydrogen gas is supplied, when a differential pressure between the inlet pressure and the outlet pressure is equal to or more than a predetermined pressure threshold, when the temperature of the heating medium is less than a predetermined temperature threshold, or when the temperature of the hydrogen gas is less than a predetermined hydrogen gas temperature threshold.
